(19) United States
(12) Patent Application Publication
(10) Pub. No.: US 2017/0260713 A1
(43) Pub. Date: Sep. 14, 2017

(54) Coupler with Visibility Window

(71) Applicant: Caterpillar Inc., Peoria, IL (US)

(72) Inventor: Matthew J. Kellerman, Garner, NC (US)

(73) Assignee: Caterpillar Inc., Peoria, IL (US)

(21) Appl. No.: 15/065,514

(22) Filed: Mar. 9, 2016

(51) Int. Cl. E02F 3/36; B66F 9/075; B66F 9/065; E02F 3/96

(52) U.S. Cl. CPC E02F 3/3609; E02F 3/3677; E02F 3/96; B66F 9/075; B66F 9/065

(57) ABSTRACT

A coupler for securing an attachment to a machine is provided. The coupler includes a front portion configured to receive an attachment and a rear portion configured for coupling to lift arms and a tilt linkage of a machine. The front portion and rear portion being defined by an upper and lower cross-members, first and second side members, and a center portion. Each of the first and second side members has a plate configuration and an intersection of the inner surface of each of the first and second side members and a lower surface of the upper cross-member forms a substantially 90° angle with first and second window openings defined between the rear portion and the front portion.

### TECHNICAL FIELD

This disclosure relates generally to a coupler and, more particularly, to a coupler with a visibility window.

### BACKGROUND

Typically, attachments or implements are coupled to mining and construction machines, such as wheel loaders, hydraulic excavators, skid steer loaders, multi-terrain loaders, track loaders, backhoe loaders, etc., to perform work. One example of such an attachment is a fork. A fork may be mounted to one of these machines for performing work, such as picking up and carrying palletized materials around a building site or at a factory. Other non-limiting examples of attachments include buckets, hammers, blades, brooms, and snow plows.

When a particular attachment is secured to the machine, it can help the machine to perform certain tasks more efficiently. Different attachments may be secured to enable the machine to perform different tasks. The ability to couple multiple attachments to a machine can increase the utility and value of the machine. However, coupling and decoupling attachments to a machine can be a cumbersome and time consuming process and the time spent switching attachments instead of working can reduce the utility of the machine.

Some attachments may be mounted to a machine with a simple pin-style joint. To create the pin-style joint, a pin is manually inserted into complementary bores in the machine and attachment. Switching attachments with this kind of pin-style joint requires an operator or technician, or multiple technicians, to manually remove the pins that hold the first attachment to the machine, remove the first attachment, position a second attachment on the machine, and manually reinsert the pins. Besides being time consuming, this switching operation may require considerable skill.

A coupler solves many of the problems that pin-style joints present for switching attachments. The coupler provides an alternative way to mount attachments to mining and construction machines. The coupler is interposed at the junction between the machine and the attachment. The attachment is secured to the coupler, and the coupler is attached to the machine. When switching attachments, the operator of the machine may operate the coupler from inside the machine's cab to release a first attachment. The machine is then repositioned near a second attachment, where the operator may then manipulate the coupler and the machine to pick up the second attachment.

One issue with existing couplers is that they can limit the ability of the operator of the machine to see the attachment that is secured to the coupler. For example, the supporting structures of the coupler can obscure the operator's view of the tines of the fork from the cab of the machine. As a result, the coupler may prevent the operator from being able to see the tines of the fork when attempting to position the pallet fork, e.g., to pick up palletized materials.

### SUMMARY

In one aspect, the disclosure describes a coupler for securing an attachment to a machine including a pair of lift arms and a tilt linkage. The coupler includes a front portion configured to receive the attachment and a rear portion configured for coupling to the lift arms and the tilt linkage. The front portion and rear portion are defined by an upper cross-member, a lower cross-member, a first side member, a second side member and a center portion. The first side member extends between the lower cross-member and the upper cross-member at respective first ends of the upper and lower cross-members. The second side member extends between the lower cross-member and the upper cross-member at respective second ends of the upper and lower cross-members that are opposite the first ends of the upper and lower cross-members. The center portion extends between the lower cross-member and the upper cross-member between the first side member and the second side member. Each of the first and second side members has a plate configuration with an substantially planar outer surface facing away from the center portion and a substantially planar inner surface facing toward the center portion. An intersection of the inner surface of each of the first and second side members and a lower surface of the upper cross-member forms a substantially 90° angle. A first window opening is defined between the rear portion and the front portion and between the inner surface of the first side member and the center portion and a second window opening is defined between the rear portion and the front portion between the inner surface of the second side member and the center portion.

In another aspect, the disclosure describes a machine including an attachment, an operator station, a frame, a pair of lift arms pivotally connected to the frame, a tilt linkage, and a coupler securing the attachment to the lift arms and the tilt linkage. The coupler includes a front portion that receives the attachment and a rear portion that connects to the lift arms and the tilt linkage. The front portion and rear portion are defined by an upper cross-member, a lower cross-member, a first side member, a second side member and a center portion. The first side member extends between the lower cross-member and the upper cross-member at respective first ends of the upper and lower cross-members. The second side member extends between the lower cross-member and the upper cross-member at respective second ends of the upper and lower cross-members that are opposite the first ends of the upper and lower cross-members. The center portion extends between the lower cross-member and the upper cross-member between the first side member and the second side member. Each of the first and second side members has a plate configuration with an substantially planar outer surface facing away from the center portion and a substantially planar inner surface facing toward the center portion An intersection of the inner surface of each of the first and second side members and a lower surface of the upper cross-member forms a substantially 90° angle. A first window opening is defined between the rear portion and the front portion and between the inner surface of the first side member and the center portion and a second window opening is defined between the rear portion and the front portion between the inner surface of the second side member and the center portion. The first and second windows provide a line-of-sight from the operator station to the attachment.

In yet another aspect, the disclosure describes a coupler for coupling an attachment to a machine including a pair of lift arms and a tilt linkage. The coupler includes a front portion configured to receive the attachment and a rear portion configured for coupling to the lift arms and the tilt linkage. The front portion and rear portion are defined by an upper cross-member, a lower cross-member, a first side member, a second side member and a center portion. The upper cross-member has a front surface on the front portion and an upper surface that faces away from the lower cross-member. A pocket is formed at an intersection between the upper side and the front side in which a first section of the upper surface is recessed downward from a second section of the upper surface toward the lower cross-member and a first section of the front surface is recessed rearward from a second section of the front surface towards the rear portion. The first side member extends between the lower cross-member and the upper cross-member at respective first ends of the upper and lower cross-members. The second side member extends between the lower cross-member and the upper cross-member at respective second ends of the upper and lower cross-members that are opposite the first ends of the upper and lower cross-members. The center portion extends between the lower cross-member and the upper cross-member between the first side member and the second side member. Each of the first and second side members has a plate configuration with a substantially planar outer surface facing away from the center portion and a substantially planar inner surface facing toward the center portion. An intersection of the inner surface of each of the first and second side members and a lower surface of the upper cross-member forms a substantially 90° angle. A first window opening is defined between the rear portion and the front portion and between the inner surface of the first side member and the center portion and a second window opening is defined between the rear portion and the front portion between the inner surface of the second side member and the center portion.

### BRIEF DESCRIPTION OF THE DRAWINGS

FIG. 1 is an isometric view of an exemplary machine having a coupler securing an attachment to the machine according to the present disclosure.

FIG. 2 is a front isometric view of the coupler of FIG. 1.

FIG. 3 is a front elevation view showing a front portion of the coupler of FIG. 1.

FIG. 4 is an rear isometric view of the coupler of FIG. 1.

FIG. 5 is a rear elevation view showing a rear portion of the coupler of FIG. 1.

FIG. 6 is an isometric view showing a line-of-sight from the operator station of the machine of FIG. 1 to the attachment through the coupler.

### DETAILED DESCRIPTION

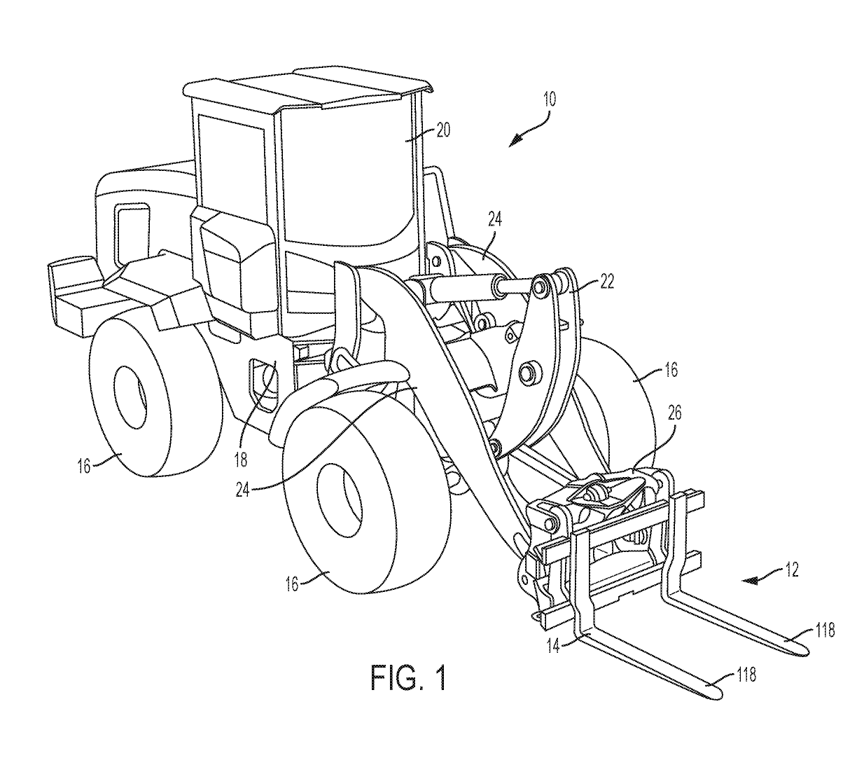

This disclosure generally relates to a coupler for securing an attachment to a machine. With reference to FIG. 1 of the drawings, an exemplary machine 10 in the form of a wheel loader is shown that can include an embodiment of a coupler constructed in accordance with principles of the present disclosure. While the machine 10 of FIG. 1 is a wheel loader, the present disclosure is applicable to any machine 10 having multiple systems and components that cooperate to accomplish a task. The machine 10 may be a fixed or mobile machine that performs some type of operation associated with an industry such as mining, construction, farming, transportation, or any other industry known in the art. For example, the machine 10 may be an earth moving machine such as an excavator, a dozer, a loader (e.g., a wheel loader or track type loader), a backhoe, a motor grader, a dump truck, or any other earth moving machine. The machine 10 may include an attachment 12, such as a bucket, fork, or other tool used to perform a task.

In the illustrated embodiment, the machine 10 may be a wheel loader, and the attachment 12 may be a fork 14, as shown in FIG. 1. The machine 10 may include wheels 16 or other ground engaging device for maneuvering, moving, or otherwise positioning the machine 10. The machine 10 may also include a frame 18 that supports an operator's station 20. The machine may also include a tilt linkage 22 and a pair of lift arms 24 that may be pivotably connected to the frame 18 for manipulating the fork 14. The lift arms 24 and tilt linkage 22 may be adapted to control the fork 14 to perform various operations, such as picking up and moving palletized or non-palletized materials. A coupler 26 may removably secure the fork 14 to the lift arms 24 and tilt linkage 22.

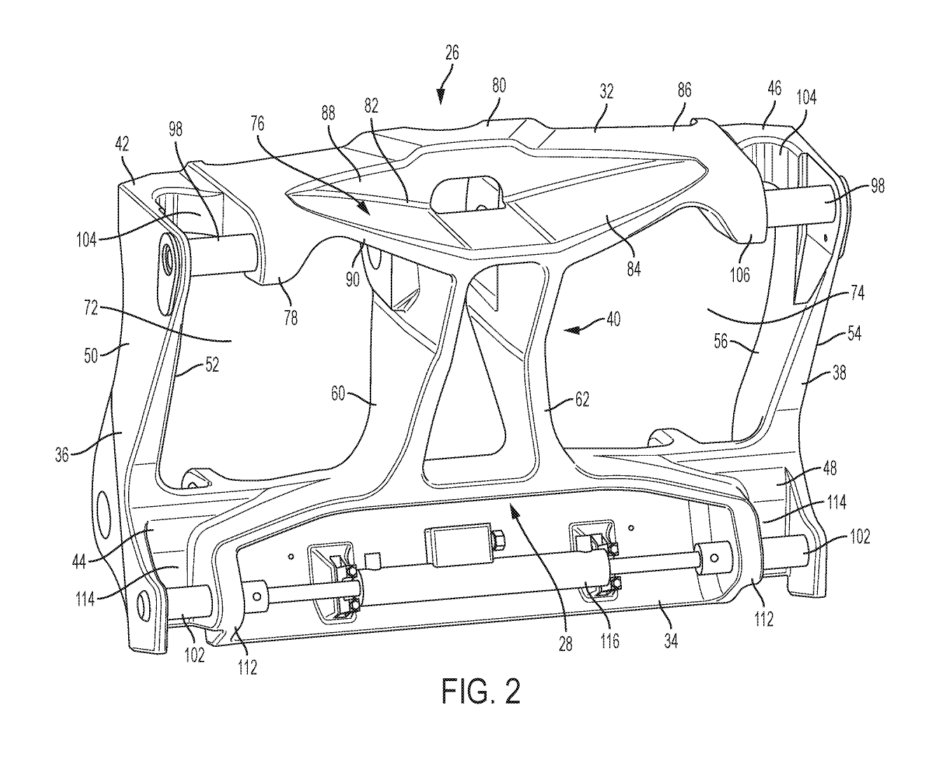

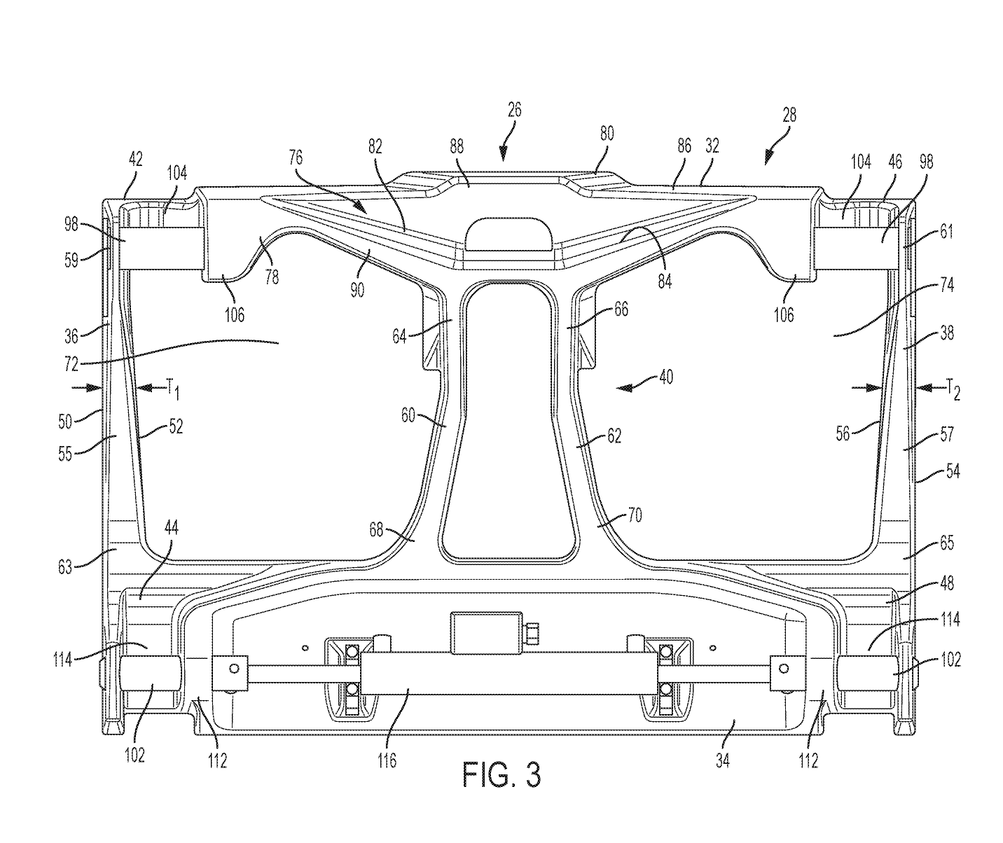

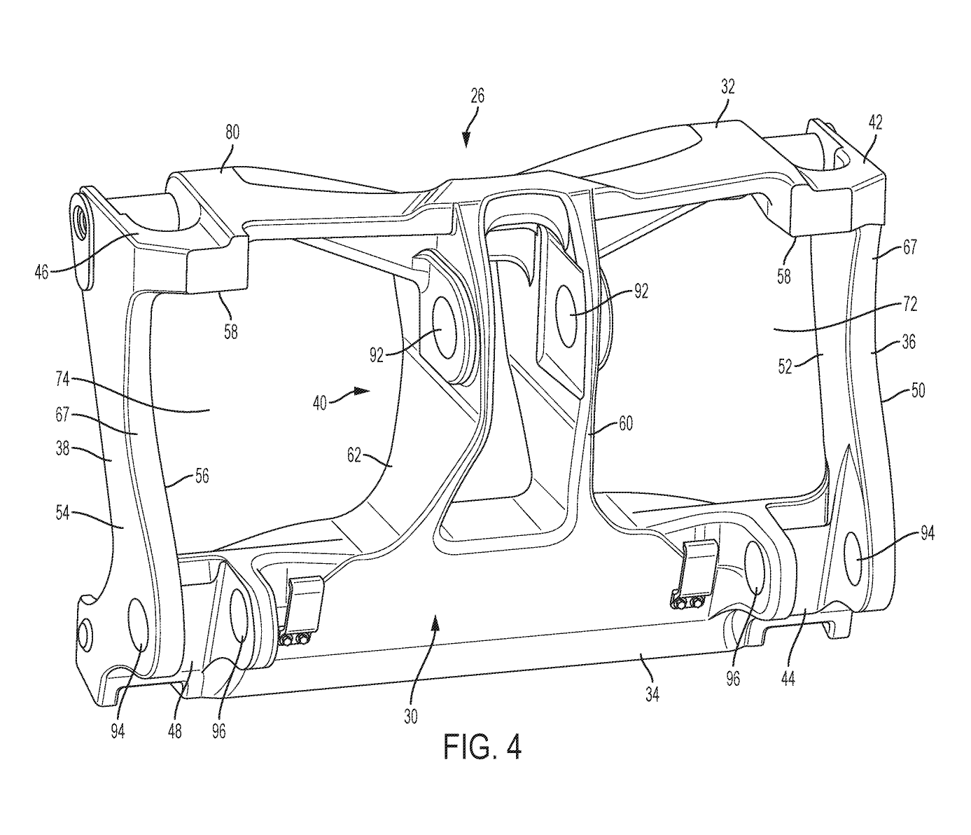

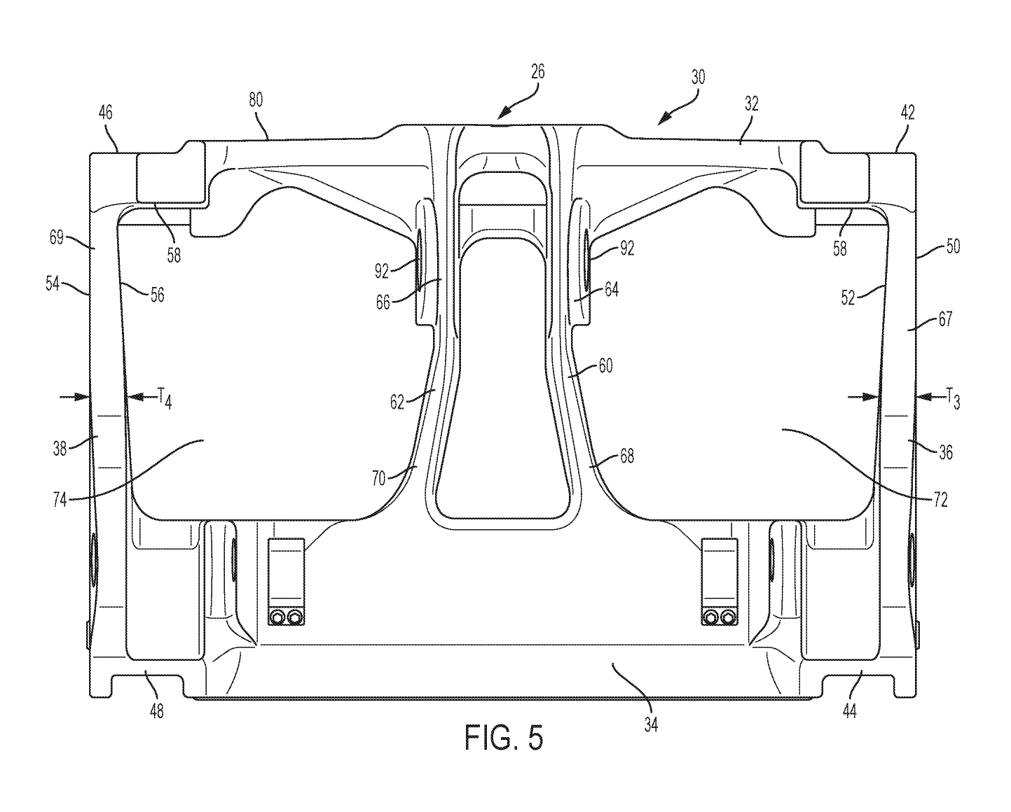

FIGS. 2-5 illustrate an exemplary embodiment of the coupler 26 unconnected from the machine 10 and the fork 14. As described in greater detail below, the coupler 26 may include a front portion 28, shown in FIGS. 2 and 3, that is configured to receive the attachment 12, in this case the fork 14. The coupler 26 may also include a rear portion 30, shown in FIGS. 4 and 5, that is configured for coupling to the lift arms 24 and the tilt linkage 22 of the machine 10 as also described in greater detail below.

The coupler 26 may include an upper cross-member 32, a lower cross-member 34, first and second side members 36, 38 and a center portion 40. The first side member 36 may extend between the upper cross-member 32 and the lower cross-member 34 at a first end 42 of the upper cross-member 32 and a first end 44 of the lower cross-member 34. Similarly, the second side member 38 may extend between the upper cross-member 32 and the lower cross-member 34 at a second end 46 of the upper cross-member 32 and a second end 48 of the lower cross-member 34 that are opposite the respective first ends 42, 44 of the upper and lower cross-members 32, 34. The center portion 40 may extend between the upper cross-member 32 and the lower cross-member 34 between the first side member 36 and the second side member 38.

As shown in FIGS. 2-5, the first side member 36 may have a plate configuration with a substantially planar outer surface 50 facing away from the center portion 40 and a substantially planar inner surface 52 facing toward the center portion 40. Likewise, the second side member 38 may also have a plate configuration with a substantially planar outer surface 54 facing away from the center portion 40 and a substantially planar inner surface 56 facing toward the center portion 40. The first and second side members 36, 38 may be configured such that an intersection of the respective inner surface 52, 56 and a lower surface 58 of the upper cross-member 32 forms a substantially 90° angle as best shown in FIG. 5.

As best shown in FIG. 3, the outer surface and the inner surface of each of the first and second side members 36, 38 may be connected by a respective front edge 55, 57 on the front portion 28 of the coupler 26. The front edge 55, 57 may have a respective thickness T1, T2 defined by a distance between the outer surface 50, 54 and the inner surface 52, 56 of the respective side member 36, 38. According to one embodiment, the thickness T1, T2 of the front edge 55, 57 may be less at an upper end 59, 61 of the respective side member 36, 38 that connects to the upper cross-member 32 than at a lower end 63, 65 of the respective side member 36, 38 that connects to the lower cross-member 34. Of course, the front edges 55, 57 may have configurations other than that specifically shown in FIGS. 2 and 3.

Additionally, the outer surface 50, 54 and the inner surface 52, 56 of each of the first and second side members 36, 38 may be connected by a respective rear edge 67, 69 on the rear portion 30 of the coupler 26 as best shown in FIG. 5. The rear edges 67, 69 may have a respective thickness T3, T4. The first and second side members 36, 38 may be configured such that the thickness T1, T2 of the front edge 55, 57 of the respective side members and the thickness T3, T4 of the rear edge 67, 69 of the respective side member are less than the distance between the front edge 55, 57 and rear edge 67, 69. Accordingly, with such a configuration, the first and second side members do not employ a box-like cross-sectional configuration and instead have a plate configuration. Again, it will be appreciated that the front and rear edges may have configurations other than that shown in FIGS. 2-5.

In the illustrated embodiment, the center portion 40 includes a first upstanding member 60 and a second upstanding member 62. The first and second upstanding members 60, 62 are spaced apart from each other with each extending between the upper cross-member 32 and the lower cross-member 34. As best shown in FIGS. 3 and 5, the first and second upstanding members 60, 62 may each include a respective upper section 64, 66 that is connected to the upper cross-member 32. The upper sections 64, 66 of the first and second cross-members may extend substantially parallel to each other. The first and second upstanding member 60, 62 may also include respective lower sections 68, 70. The lower sections 68, 70 of the first and second upstanding members 60, 62 may be connected to the respective upper section 64, 66 and the lower cross-member 34. The lower sections 68, 70 may further be configured such that they diverge from one another as they extend from the respective upper section 64, 66 to the lower cross-member 34.

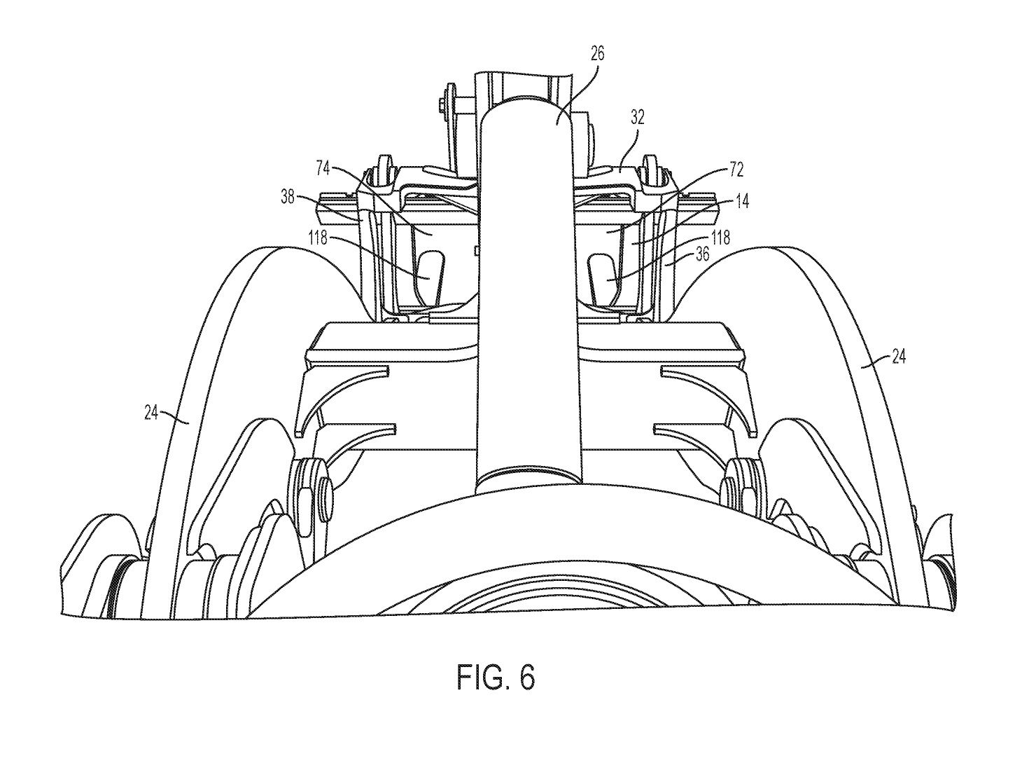

To provide a line-of-sight from a operator in the operator's station 20 of the machine 10 to the attachment 12, the coupler 26 may be configured with first and second visibility windows 72, 74. An example of the operator's line-of-sight to the fork 14 through the first and second visibility windows 72, 74 is provided in FIG. 6. The first visibility window 72 may be defined between the rear portion 30 and the front portion 28 of the coupler 26 and between the inner surface 52 of the first side member 36 and the center portion 40 and, in particular, the first upstanding member 60. Similarly, the second visibility window 74 may be defined between the rear portion 30 and the front portion 28 and between the inner surface 56 of the second side member 38 and the center portion 40 and, more particularly, the second upstanding member 62. According to one embodiment, the center portion 40 may include only the single first and second upstanding members 60, 62. In such embodiment, the first visibility window 72 may be substantially unobstructed between the inner surface 52 of the first side member 36 and the first upstanding member 60 and the second visibility window 74 may be substantially unobstructed between the inner surface 56 of the second side member 38 and the second upstanding member 62.

The upper cross-member 32 may be configured with a pocket 76 formed therein as shown in FIGS. 2 and 3. More particularly, the upper cross-member 32 may include a front surface 78 on the front portion 28 of the coupler 26 and an upper surface 80 that faces away from the lower cross-member 34. The pocket 76 may be formed at an intersection 80 between the front surface 78 and the upper surface 80. The pocket 76 may include a first section 84 of the upper surface 80, which is recessed downward from a second section 86 of the upper surface 80 toward the lower cross-member 34. The pocket 76 may further include a first section 88 of the front surface 78 that is recessed rearward from a second section 90 of the front surface 78 toward the rear portion 30 of the coupler 26. It will be appreciated that the pocket 76 in the upper cross-member 32 may have configurations other than that specifically shown in FIGS. 2 and 3.

As shown in FIGS. 4 and 5, to secure the rear portion 30 of the coupler 26 to the machine 10, the upper section 64, 66 of each of the first and second upstanding members 60, 62 of the center portion 40 may have an opening 92 therein that is configured to receive a pin for attaching the coupler 26 to the tilt linkage 22. Additionally, each of the first and second side members 36, 38 may have a first opening 94 near the lower end of the respective side member 36, 38 on the rear portion 30 of the coupler 26. A corresponding second opening 96 may be provided in a respective flange extending from the lower cross-member 34 on the rear portion 30 of the coupler 26 opposite the respective first openings 94. Each set of first and second openings 94, 96 may be configured to receive a pin for attaching the rear portion 30 of the coupler 26 to a respective one of the lift arms 24.

To secure an attachment 12 to the front portion 28 of the coupler 26, the front portion 28 may include an upper pair of pins 98 and a lower pair of pins 102. As shown in FIGS. 2 and 3, an upper pin 98 may extend across a gap 104 between the upper end of each of the first and second side members 36, 38 and a corresponding end portion 106 of the upper cross-member 32. Additionally, a lower pin 102 may extend across a gap 114 between the lower end of each of the first and second side members 36, 38 on the front portion 28 of the coupler 26 and a corresponding a flange 112 extending from the lower cross-member 34. These lower pins 102 may be extended and retracted from the corresponding gaps 114 between the lower ends of the first and second side members 36, 38 and the flanges 112 by an actuator 116 that may be mounted to the lower cross-member 34. As will be appreciated, the configuration and location of the various pins and openings on the front and rear portions of the coupler may vary depending upon the configuration of the machine 10 and/or the attachment 12.

### INDUSTRIAL APPLICABILITY

The coupler 26 of the present disclosure is applicable to any type of machine to which an attachment may be secured in order to perform work. The coupler 26 may provide several advantages including ease of use and ease of attachment to the machine and the attachment.

The coupler 26 of the present disclosure may also provide greater visibility for the operator of the machine 10 in the operator's station 20. FIG. 6 illustrates this greater visibility in an exemplary embodiment. In particular, FIG. 6 shows the line-of-sight from an operator in the operator's station 20 of the machine 10 through the visibility windows 72, 74 of the coupler to the attachment 12, in this case the fork 14, secured to the lift arms 24 and tilt linkage 22 of the machine 10. As can be seen from FIG. 6, the configurations of the visibility windows 72, 74 may allow the operator to see through the coupler 26 to the tines 118 of the fork 14, e.g., the distal ends of the tines 118, thereby enabling the operator to see when the tines are positioned properly to engage or lift materials, e.g., to position the tines 118 in a pallet. For example, the operator may view one of the tines 118 of the fork 14 through one of the windows 72, 74 and the other one of the tines 118 through the other one of the windows 72, 74. As a result, providing one or more of the windows gives the operator increased confidence and increases the efficiency of the operation, e.g., the handling and transport of palletized and/or non-palletized materials with the fork.

The size of the visibility windows 72, 74 in the coupler of the present disclosure may be larger and/or have an improved configuration because of the plate configuration of the side members 36, 38 relative to couplers that utilize relatively wider, box shaped side sections. The visibility through the windows 72, 74 in the coupler of the present disclosure is also improved as a result of the substantially 90° angle between the inner surface 52, 56 of each of the first and second side members 36, 38 and the lower surface 58 of the upper cross-member 32 particularly as compared to couplers that use relatively large reinforcing flanges in these corners.

Additionally, the coupler 26 of the present disclosure allows for increased visibility for the operator while remaining useable with various types of implements, such as buckets and other types of implements for which the operator may not necessarily desire to have increased visibility. As a result, since various types of implements may be used with the disclosed coupler, the design may be versatile and less costly to manufacture and use.

This disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A coupler for securing an attachment to a machine including a pair of lift arms and a tilt linkage, the coupler comprising:
a front portion configured to receive the attachment and a rear portion configured for coupling to the lift arms and the tilt linkage, the front portion and rear portion being defined by:
an upper cross-member;
a lower cross-member;
a first side member extending between the lower cross-member and the upper cross-member at respective first ends of the upper and lower cross-members;
a second side member extending between the lower cross-member and the upper cross-member at respective second ends of the upper and lower cross-members that are opposite the first ends of the upper and lower cross-members; and
a center portion extending between the lower cross-member and the upper cross-member between the first side member and the second side member;
each of the first and second side members having a plate configuration with a substantially planar outer surface facing away from the center portion and a substantially planar inner surface facing toward the center portion, an intersection of the inner surface of each of the first and second side members and a lower surface of the upper cross-member forming a substantially 90° angle;
wherein a first window opening is defined between the rear portion and the front portion and between the inner surface of the first side member and the center portion and a second window opening is defined between the rear portion and the front portion between the inner surface of the second side member and the center portion.

2. The coupler of claim 1 wherein the center portion includes a first upstanding member and a second upstanding member that are spaced apart from each other, each of the first and second upstanding members extending between the upper cross-member and the lower cross-member with the first window defined between the inner surface of the first side member and the first upstanding member and the second window defined between the inner surface of the second side member and the second upstanding member.

3. The coupler of claim 2 wherein the first upstanding member and the second upstanding member each include a respective upper section connected to the upper cross-member, the upper section of the first upstanding member is substantially parallel to the upper section of the second upstanding member and wherein the first upstanding member and the second upstanding member each include a respective lower section connected to the respective upper section and to the lower cross-member, the lower section of first upstanding member and the lower section of the second upstanding member diverge from one another as they extend from the respective upper section to the lower cross-member.

4. The coupler of claim 2 wherein center portion includes only a single first upstanding member and a single second upstanding member and the first window is substantially unobstructed between the inner surface of the first side member and the first upstanding member and the second window is substantially unobstructed between the inner surface of the second side member and the second upstanding member.

5. The coupler of claim 3 wherein the upper cross-member has a front surface on the front portion and an upper surface that faces away from the lower cross-member, a pocket being formed at an intersection between the upper surface and the front surface in which a first section of the upper surface is recessed downward from a second section of the upper surface toward the lower cross-member and a first section of the front surface is recessed rearward from a second section of the front surface towards the rear portion.

6. The coupler of claim 1 wherein the outer surface and the inner surface of each of the first and second side members are connected by a respective front edge on the front portion, the front edge having a thickness defined by a distance between the outer surface and inner surface, the thickness of the front edge being less at an upper end of the respective side member that connects to the upper cross-member than at a lower end of the respective side member that connects to the lower cross-member.

7. The coupler of claim 6 wherein the outer surface and the inner surface of each of the first and second side members are connected by a respective rear edge on the rear portion, the thickness of the front edge and the thickness of the rear edge are less than the distance between the front edge and the rear edge.

8. The coupler of claim 3 wherein the upper section of the first upstanding member and the upper section of the second upstanding member each have an opening therein configured to receive a pin for attaching the coupler to the tilt linkage.

9. A machine comprising:
an attachment;
an operator station;
a frame;
a pair of lift arms pivotally connected to the frame;
a tilt linkage; and
a coupler securing the attachment to the lift arms and the tilt linkage, the coupler including a front portion that receives the attachment and a rear portion that connects to the lift arms and the tilt linkage, the front portion and rear portion being defined by:
an upper cross-member;
a lower cross-member;
a first side member extending between the lower cross-member and the upper cross-member at respective first ends of the upper and lower cross-members;
a second side member extending between the lower cross-member and the upper cross-member at respective second ends of the upper and lower cross-members that are opposite the first ends of the upper and lower cross-members; and
a center portion extending between the lower cross-member and the upper cross-member between the first side member and the second side member;
each of the first and second side members having a plate configuration with a substantially planar outer surface facing away from the center portion and a substantially planar inner surface facing toward the center portion, an intersection of the inner surface of each of the first and second side members and a lower surface of the upper cross-member forming a substantially 90° angle;
wherein a first window opening is defined between the rear portion and the front portion and between the inner surface of the first side member and the center portion and a second window opening is defined between the rear portion and the front portion between the inner surface of the second side member and the center portion, the first and second windows providing a line-of-sight from the operator station to the attachment.

10. The machine of claim 9 wherein the center portion includes a first upstanding member and a second upstanding member that are spaced apart from each other, each of the first and second upstanding members extending between the upper cross-member and the lower cross-member with the first window defined between the inner surface of the first side member and the first upstanding member and the second window defined between the inner surface of the second side member and the second upstanding member.

11. The machine of claim 10 wherein the first upstanding member and the second upstanding member each include a respective upper section connected to the upper cross-member, the upper section of the first upstanding member is substantially parallel to the upper section of the second upstanding member and wherein the first upstanding member and the second upstanding member each include a respective lower section connected to the respective upper section and to the lower cross-member, the lower section of first upstanding member and the lower section of the second upstanding member diverge from one another as they extend from the respective upper section to the lower cross-member.

12. The machine of claim 10 wherein center portion includes only a single first upstanding member and a single second upstanding member and the first window is substantially unobstructed between the inner surface of the first side member and the first upstanding member and the second window is substantially unobstructed between the inner surface of the second side member and the second upstanding member.

13. The machine of claim 11 wherein the upper cross-member has a front surface on the front portion and an upper surface that faces away from the lower cross-member, a pocket being formed at an intersection between the upper surface and the front surface in which a first section of the upper surface is recessed downward from a second section of the upper surface toward the lower cross-member and a first section of the front surface is recessed rearward from a second section of the front surface towards the rear portion.

14. The machine of claim 9 wherein the outer surface and the inner surface of each of the first and second side members are connected by a respective front edge on the front portion, the front edge having a thickness defined by a distance between the outer surface and inner surface, the thickness of the front edge being less at an upper end of the respective side member that connects to the upper cross-member than at a lower end of the respective side member that connects to the lower cross-member.

15. The machine of claim 14 wherein the outer surface and the inner surface of each of the first and second side members are connected by a respective rear edge on the rear portion, the thickness of the front edge and the thickness of the rear edge are less than the distance between the front edge and the rear edge.

16. The machine of claim 11 wherein the upper section of the first upstanding member and the upper section of the second upstanding member each have an opening therein configured to receive a pin for attaching the coupler to the tilt linkage.

17. A coupler for coupling an attachment to a machine including a pair of lift arms and a tilt linkage, the coupler comprising:
a front portion configured to receive the attachment and a rear portion configured for coupling to the lift arms and the tilt linkage, the front portion and rear portion being defined by:
an upper cross-member, the upper cross-member having a front surface on the front portion and an upper surface that faces away from the lower cross-member, a pocket being formed at an intersection between the upper surface and the front surface in which a first section of the upper surface is recessed downward from a second section of the upper surface toward the lower cross-member and a first section of the front surface is recessed rearward from a second section of the front surface towards the rear portion;
a lower cross-member;
a first side member extending between the lower cross-member and the upper cross-member at respective first ends of the upper and lower cross-members;
a second side member extending between the lower cross-member and the upper cross-member at respective second ends of the upper and lower cross-members that are opposite the first ends of the upper and lower cross-members; and
a center portion extending between the lower cross-member and the upper cross-member between the first side member and the second side member;
each of the first and second side members having a plate configuration with a substantially planar outer surface facing away from the center portion and a substantially planar inner surface facing toward the center portion, an intersection of the inner surface of each of the first and second side members and a lower surface of the upper cross-member forming a substantially 90° angle;
wherein a first window opening is defined between the rear portion and the front portion and between the inner surface of the first side member and the center portion and a second window opening is defined between the rear portion and the front portion between the inner surface of the second side member and the center portion.

18. The coupler of claim 17 wherein the center portion includes a single first upstanding member and a single second upstanding member that are spaced apart from each other, each of the first and second upstanding members extending between the upper cross-member and the lower cross-member with the first window defined between the inner surface of the first side member and the first upstanding member and the second window defined between the inner surface of the second side member and the second upstanding member and wherein the first window is substantially unobstructed between the inner surface of the first side member and the first upstanding member and the second window is substantially unobstructed between the inner surface of the second side member and the second upstanding member.

19. The coupler of claim 18 wherein the outer surface and the inner surface of each of the first and second side members are connected by a respective front edge on the front portion, the front edge having a thickness defined by a distance between the outer surface and inner surface, the thickness of the front edge being less at an upper end of the respective side member that connects to the upper cross-member than at a lower end of the respective side member that connects to the lower cross-member.

20. The coupler of claim 18 wherein the outer surface and the inner surface of each of the first and second side members are connected by a respective rear edge on the rear portion, the thickness of the front edge and the thickness of the rear edge are less than the distance between the front edge and the rear edge.
